(19) United States
(12) Patent Application Publication
(10) Pub. No.: US 2013/0147615 A1
(43) Pub. Date: Jun. 13, 2013

(54) HAZARD WARNING DEVICE AND METHOD FOR VEHICLES

(71) Applicants: Cheng-Hsien Chen, Taoyuan (TW); Kuei-Neng Wu, Taipei (TW); Wei-Yun Liang, Hsinchu (TW); Shih-Chin Kao, Yunlin (TW)

(72) Inventors: Cheng-Hsien Chen, Taoyuan (TW); Kuei-Neng Wu, Taipei (TW); Wei-Yun Liang, Hsinchu (TW); Shih-Chin Kao, Yunlin (TW)

(73) Assignee: Industrial Technology Research Institute, Hsinchu (TW)

(21) Appl. No.: 13/404,089

(22) Filed: Feb. 24, 2012

(30) Foreign Application Priority Data
Dec. 7, 2011 (TW) 100145100

(51) Int. Cl. B60Q 1/00

(52) U.S. Cl. 340/425.5

(57) ABSTRACT

A hazard warning device for vehicles is provided, including a light source unit, a light guiding unit, a warning structure unit and a control unit. The light source unit generates a light source for warning. The light guiding unit guides the light source to become a surface light source having an area. The warning structure unit scatters or reflects the surface light source and displays a warning. The control unit is the element for controlling the on and off of the light source unit. When the control unit receives an activation signal from a vehicle, the control unit activates the light source unit and displays a warning on a surface area of the vehicle through the light guiding unit and the warning structure unit.

### CROSS-REFERENCE TO RELATED APPLICATION

The present application is based on, and claims priority from, Taiwan Application No. 100145100, filed Dec. 7, 2011, the disclosure of which is hereby incorporated by reference herein in its entirety.

### TECHNICAL FIELD

The present disclosure generally relates to a hazard warning device and method for vehicles.

### BACKGROUND

Many accidents occur due to the situation when the car or motorcycle driver in moving collides with the door of a vehicle that stops at roadside and suddenly opens its door. Usually a vehicle warning device may be able to warn people in a vehicle to pay attention to the coming vehicle behind when the door is going to be opened. Whether day or night, it is often unpredictable that a vehicle or motorcycle driver knowing a vehicle such as stalled at roadside opens its door. Although the vehicle driver pays careful attention to the coming vehicle behind when he is going to open the door, but the human factor is sometimes difficult to control.

There are many technical literatures used to warn passengers in the vehicle and the coming vehicle behind. For example, a technology discloses a warning edge strip for car doors. This technique activates a warning light on the car doors through sensed sensor when the door is open. A technical literature reveals the structure of a vehicle rear-view mirror, including a hollow case located at both sides of the vehicle front seat and a front mirror located at the front of the hollow case. The technology uses a flash bulb in a concaved window at the back of the hollow case, synchronized operates with the indication lights of the vehicle, and achieves a shining warning of changing direction by using a guiding light mask that covers over the window.

A technical literature discloses a door security warning light. The technique uses two shades and two light sources to warn passengers and coming vehicles behind with different light sources. Another technical literature provides a warning light for vehicles. This technology uses the flash mode of multiple light emitting diodes (LEDs) to light up, and controls the light to be emitted in parallel. Yet another technical literature provides a method and apparatus for preventing harm and material damage caused by the motorcycle. This technology utilizes one or more monitoring units to monitor external space, and to monitor the door handle with detecting and turning on an operation mode, and then outputs a warning signal.

Nowadays technologies of skilled backlight module and guiding light for display industry have been developed. The light-emitting of backlight module works by light-emitting diodes (LEDs) or cold cathode fluorescent lamps (CCFLs) providing the incident light source, utilizes a guiding light plate for guiding the light, and outputs light after reflection of a reflected point on the guiding light plate. While some guiding light portions may be made of a soft guiding light film. Therefore, the applications of relevant technologies in traffic warning may better protect the personal transportation safety. In wide range of applications of the vehicle warning technology, a method of improving the warning effect and providing in time and eye-catching, to remind the coming vehicle behind paying attention to such as opening the car door or moving of the front vehicle, so that the coming vehicle behind may pat attention to the door of which direction is going to open, and occurrence of many accidents may be avoided.

Therefore, the vehicle warning technology that utilizes features such as small size, high brightness, lightweight, easy changing color, or light-emitting frequency (flicker) and others to improve warning effect, and in time to prevent accident caused by the collision of the coming vehicle behind and the front vehicle is very worthy of being studied and developed.

### SUMMARY

According to one exemplary embodiment, there is provided a hazard warning device for vehicles. The hazard warning device comprises a light source unit, a light guiding unit, a warning structure unit, and a control unit. The light source unit generates at least one light source for warning. The light guiding unit guides the light source to become a surface light source. The warning structure unit scatters or reflects the surface light source and displays a warning. The control unit is an element for controlling the on and off for the light source unit. When the control unit receives an unlocked signal or a stall signal from a vehicle, the control unit activates the light source unit and a warning is displayed on a surface area of the vehicle via the light guiding unit and the warning structure unit.

According to another exemplary embodiment, there is provided a hazard warning method for vehicles, The method comprises: using a light source unit to generate at least one light source for warning; guiding the light source to become a surface light source, scattering or reflecting the surface light source and displaying a warning; and using a control unit to control the on and off for the light source unit. When the control unit receives an unlocked signal or a stall signal from a vehicle, the control unit activates the light source unit and a warning is displayed on a surface area of the vehicle

The foregoing and other features, aspects and advantages of the exemplary embodiments will become better understood from a careful reading of a detailed description provided herein below with appropriate reference to the accompanying drawings.

### BRIEF DESCRIPTION OF THE DRAWINGS

FIG. 1 shows a block diagram illustrating a hazard warning device for vehicle, according to an exemplary embodiment.

FIG. 2 shows a schematic view of the hazard warning device using vehicle windows as guiding light material, and the generated light source entering into the light guiding unit via a light tube guiding element, according to an exemplary embodiment.

FIG. 3 shows a schematic view of the hazard warning device using vehicle windows as guiding light material, and the generated light source entering directly into the light guiding unit, according to an exemplary embodiment.

FIG. 4 shows a schematic view of attaching the light guiding unit and the warning structure unit of the vehicle warning device to a vehicle window, according to an exemplary embodiment.

FIG. 5 shows a schematic view of displaying warning for the warning structure unit, according to an exemplary embodiment.

FIG. 6 shows a flow chart of the procedures describing the control unit controls turning off or on of the light source unit, according to an exemplary embodiment.

FIG. 7 shows a timing diagram of turning on or off the light source unit controlled by the control unit controlled by the control unit when the signal is a vehicle door lock signal, according to an exemplary embodiment.

FIG. 8 shows a timing diagram of turning on or off the light source unit controlled by the control unit controlled by the control unit when the signal is a vehicle key status signal, according to an exemplary embodiment.

FIG. 9 shows a hazard warning method for vehicles, according to an exemplary embodiment.

### DETAILED DESCRIPTION OF DISCLOSED EMBODIMENTS

In accordance with the exemplary embodiments, the disclosed hazard warning device and method for vehicles utilizes a light source unit of small size and high brightness to enter into a light guiding unit. The light guiding unit is coupled with a warning structure unit of easily changing color or light frequency. With the switching by a control unit according to the warning design of application requirements, such as word patterns, graphic patterns or images, the light guiding unit is combined with vehicle windows to gather the light source onto the vehicle windows or a light guiding film. The exemplary embodiments of the hazard warning device and method utilize available spaces (e.g., window sides of the vehicle, etc.) for entering light source and use car windows or the light guiding film as guiding light material, to emit the light source or display the warning notices from a large surface area.

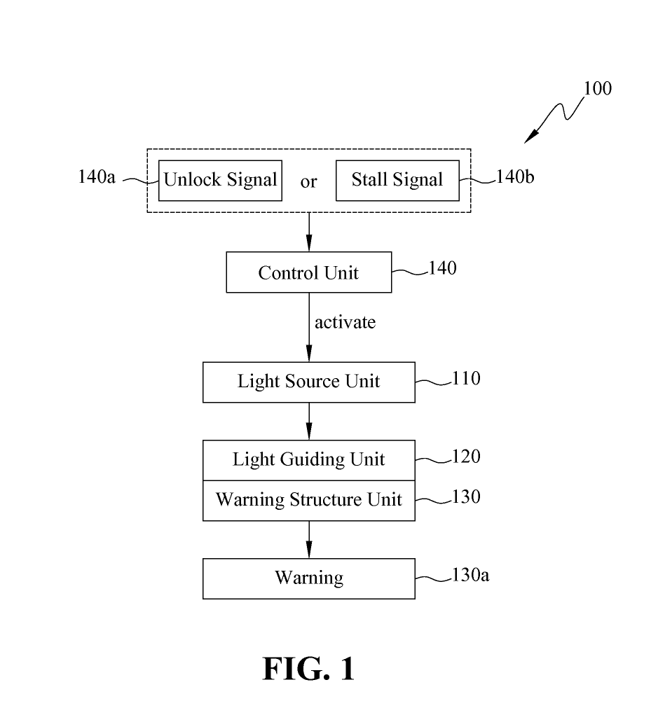

FIG. 1 shows a block diagram of a hazard warning device for vehicle, according to an exemplary embodiment. Referring to FIG. 1, a vehicle warning device 100 comprises a light source unit 110, a light guiding unit 120, a warning structure unit 130, and a control unit 140. The light source unit 110 generates a light source for warning 110a. The light guiding unit 120 guides the light source 110a to become a surface light source having an area. The warning structure unit 130 scatters or reflects the surface light source and displays a warning 130a. The control unit 140 is an element for controlling the on and off of the light source unit 110a. When the control unit 140 unit receives an unlock signal 140a or a stall signal 140b from a vehicle, the light source unit 110 is activated and a warning 130a is displayed on a surface area of the vehicle via the light guiding unit 120 and the warning structure unit 130. The control unit 140 also receives an off signal of the vehicle, and turns off the light source unit 110 to terminate the warning 130a displayed by the warning structure unit 130.

According to the exemplary embodiments, the light source unit 110 may be one or more light-emitting diodes (LEDs), cold cathode fluorescent lamps (CCFLs), or other light sources. The light source 110a generated by the light source unit 110 may directly or through a light tube guiding element enter into the light guiding unit 120, and may be switched by the control unit 140 as flashing or constant light. The light tube guiding element may take the light source unit 110 through an optical fiber, an optical fiber bundle or a guiding light device to lead the light source 110a to the light guiding unit 120. The light guiding unit 120 is a device of guiding light structure, which may perform transmission via light medium, guide the light source generated by the light guiding unit 110 to become a surface light source having an area.

According to the exemplary embodiments, the light guiding unit 120 may be a guiding light film, a guiding light plate, or vehicle windows, or the vehicle back windshield, etc., or any combination of the aforementioned. The warning structure unit 130 may be an element with scattered or reflected structure. This element with scattered or reflected structure may be combined with the light guiding unit 120. The warning 130a may also be required by the applications to display warning designs of word patterns, graphic patterns or images, etc.

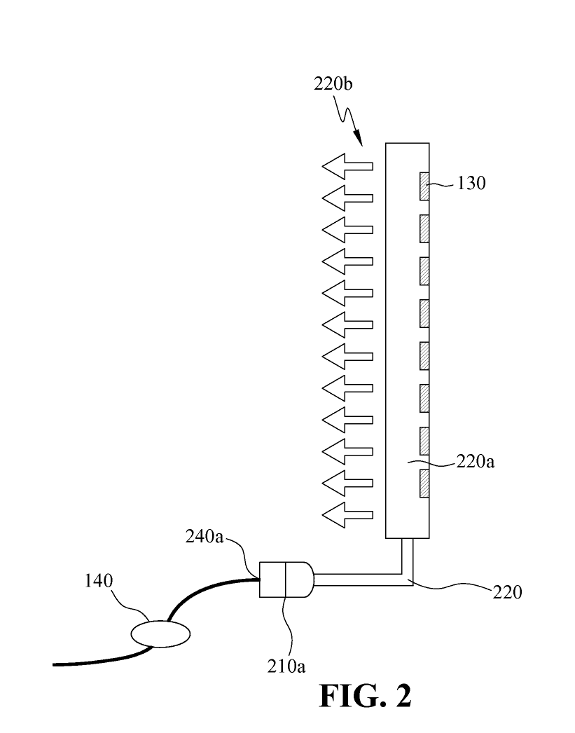

FIG. 2 shows a schematic view illustrating the hazard warning device using directly vehicle window as guiding light material, according to an exemplary embodiment. In the exemplary embodiment, the light source 110a generated by the light source unit 110 may enter into the light guiding unit 120 via a light tube guiding element. Referring to FIG. 2, one end 240a of the control unit 140 is connected to the light source unit 110 such as LED 210a. The light source generated by LED 210a enters into the light guiding unit 120 such as a vehicle window 220a via a light tube guiding element 220, and may further be switched by the control unit 140 to flashing or constant light and so on. The light tube guiding element 220 may be such as a fiber or a light tube, etc., which may depend on application requirements. The light tube guiding element 220 bonds closely with the light guide unit 120 such as a vehicle window 220a, and leads light source generated by the LED 210a to the light guiding unit 120 such as the vehicle window 220a and emits this light source from a large surface area (as shown by a label 220b) on the light guiding unit 120 such as the vehicle window 220a to become a surface light source. The warning structural unit 130 scatters or reflects this surface light source and displays warning on the vehicle window 220a. This warning may be designed as word patterns, graphic patterns, or images, or any combination of the aforementioned.

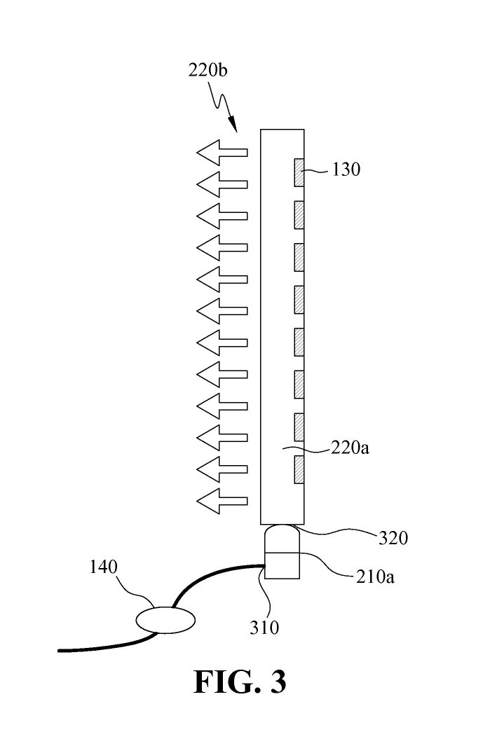

According to another exemplary embodiment, the light source generated by the light source unit 110 such as LED 210a may enter directly into the light guide unit 120 and be switched by the control unit 140 as flashing or constant light. FIG. 3 illustrates the exemplary embodiment. Referring to FIG. 3, one end 310 of LED 210a connects to the control unit 140 and the other end 320 connects directly to the vehicle window 220a, so the light source generated by the LED 210a enters directly into the light guiding unit such as vehicle window 220a. The light source generated by this LED 210a is emitted from a large surface area (as shown by label 220b) on the vehicle window 220a and becomes a surface light source.

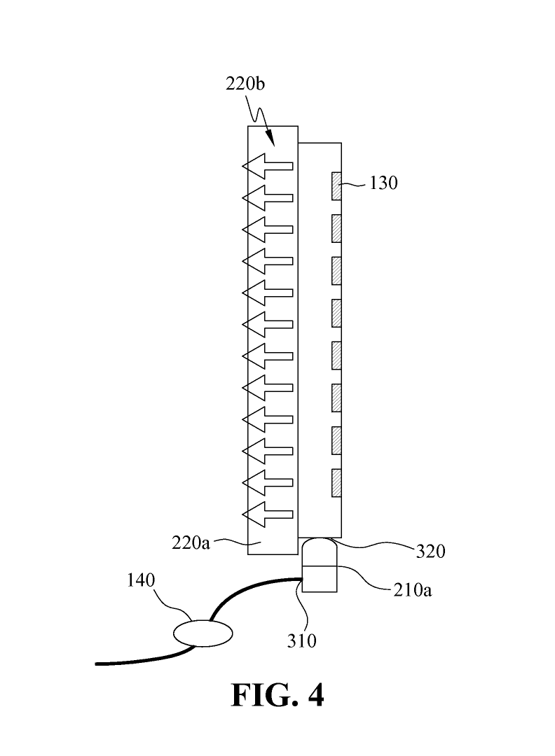

FIG. 4 shows a schematic view of attaching the light guiding unit and the warning structure unit of the vehicle warning device to a vehicle window, according to an exemplary embodiment. Referring to FIG. 4, the light guiding unit 120 acts as an guiding light material. Both the light guiding unit 120 and the warning structure unit 130 are attached to the vehicle window 220a. The light source is emitted from or a warning is displayed on a large surface area on the vehicle window 220a by the vehicle window 220a and the guiding light material. In other words, the vehicle window may combine with LED light source on the vehicle window or connect the light source to an external guiding light material, input the light by using the side areas or other available spaces, and output the light source from a large surface area on the vehicle window or appear warning's word or graphic patterns via the vehicle window or the external guiding light material.

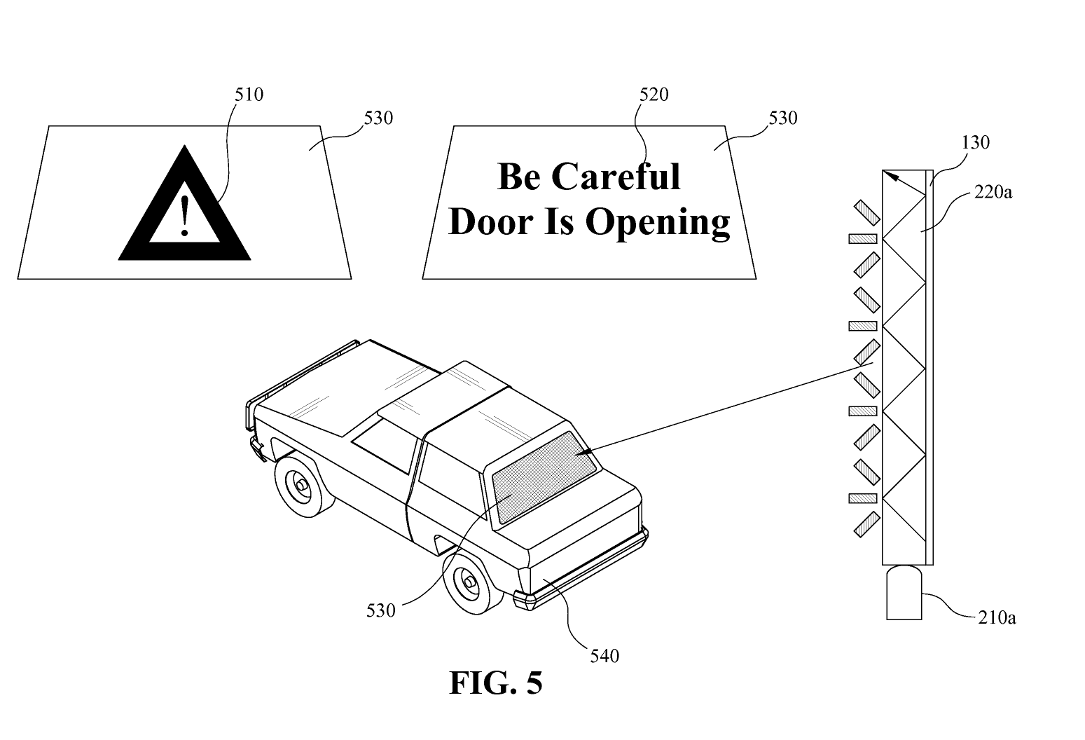

FIG. 5 shows a schematic view of displaying warning for the warning structure unit, according to an exemplary embodiment. Referring to FIG. 5, the warning structure unit 130 displays warning such as a warning pattern 510 or warning words (e.g. Be Careful, Door Is Opening 520) on a region of the rear windshield 530 of the vehicle 540. In other words, the light guiding unit takes the vehicle's rear windshield as guiding light material. The warning structure unit 130 may be made on the rear windshield.

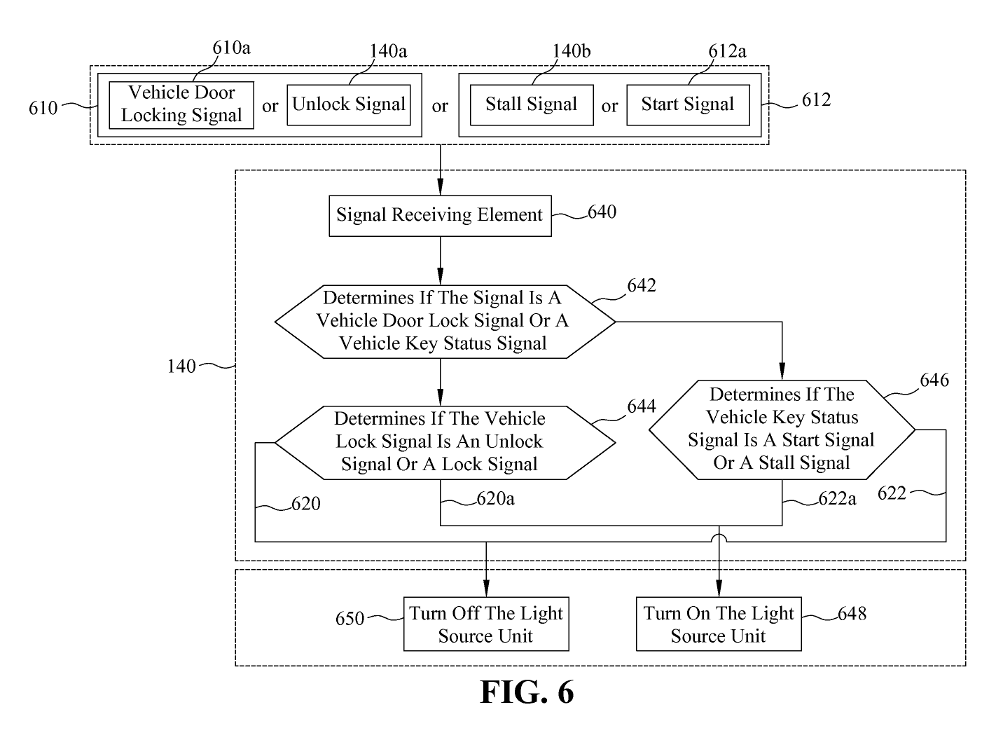

FIG. 6 shows a flow chart of the procedures describing the control unit 140 controls turning off or on of the light source unit 110, according to an exemplary embodiment. Referring to FIG. 6, the control unit 140 further includes a signal receiving element 640 to receive a signal. The signal may be a vehicle door lock signal 610 or a vehicle key status signal 612. Wherein, when the vehicle door is unlocked, the vehicle door lock signal 610 issued is unlock signal 140a; when the vehicle door is locked, the vehicle door lock signal 610 issued is vehicle door locking signal 610a. The vehicle key status signal 612 is a start signal 612a or a stall signal 140b. The control unit 140 first determines if the signal is vehicle door lock signal 610 or vehicle key status signal 612, as shown in label 642. When the signal is a vehicle door lock signal 610, the control unit 140 then determines the vehicle door lock signal 610 is a locking signal or an unlocked signal, as shown in label 644. When the signal is vehicle key status signal 612, the control unit 140 determines again the vehicle key status signal 612 is a start signal 612a or a stall signal 140b, as shown in label 646. When the vehicle door lock signal 610 is an unlock signal 140a, the control unit 140 issues an unlock status turn on light source signal 620a or when the vehicle key status signal 612 is a stall signal 140b, the control unit 140 issues a stall status turn on light source signal 622a, the control unit 140 turns on the light source unit 110, as shown in label 648. When the vehicle door lock signal 610 is vehicle door locking signal 610a, the control unit 140 issues a lock status turn off light source signal 620 or when the vehicle key status signal 612 is the start signal 612a, the control unit 140 issues a start status turn off light source signal 622, the control unit 140 turns off the light source unit 110, as shown in label 650.

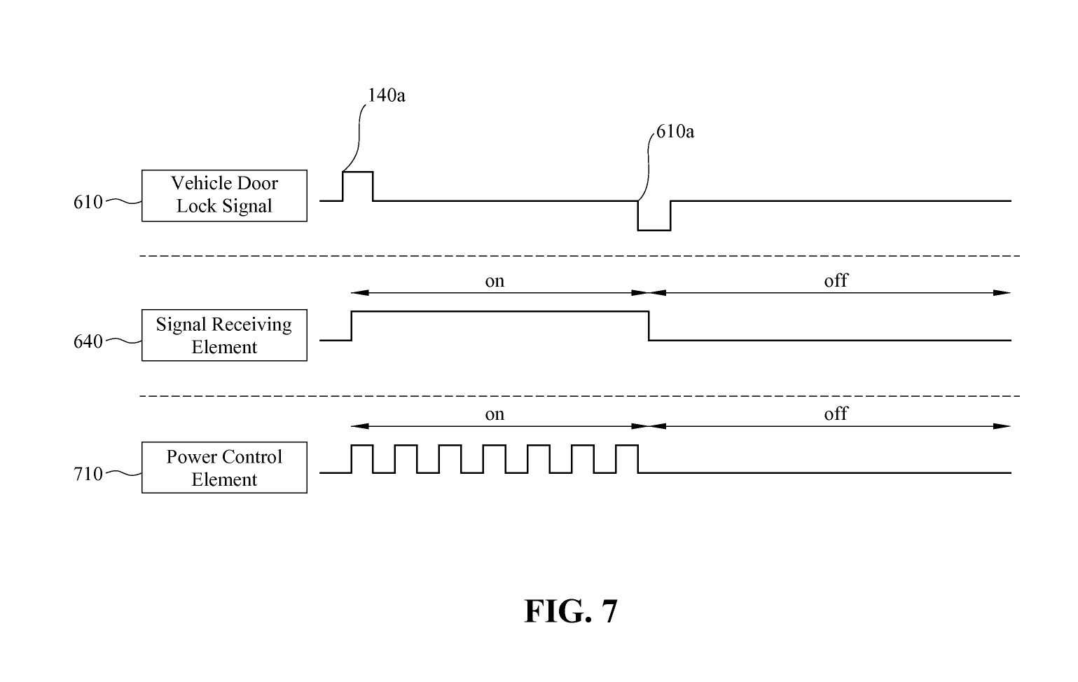

Accordingly, the control unit 140 further includes a power control element to turn off or turn on the light source unit 110. FIG. 7 shows a timing diagram of turning on or off the light source unit 110 controlled by the control unit 140 when the signal is vehicle door lock signal 610, according to an exemplary embodiment. Referring to FIG. 7, when the vehicle door is unlocked, unlock signal 140a is issued. After the signal receiving element of the control unit 140 receives that the vehicle door lock signal 610 is unlock signal 140a, it notifies the power control element 710 for supplying power to light source unit 110 to turn on the power. When the vehicle door is locked, the signal receiving element 640 of the control unit 140 receives that the vehicle door lock signal 610 is door locking signal 610a, the control unit 140 issues lock status turn off light source signal 620 and notifies the power control element for supplying power to light source unit 110 to turn off the power.

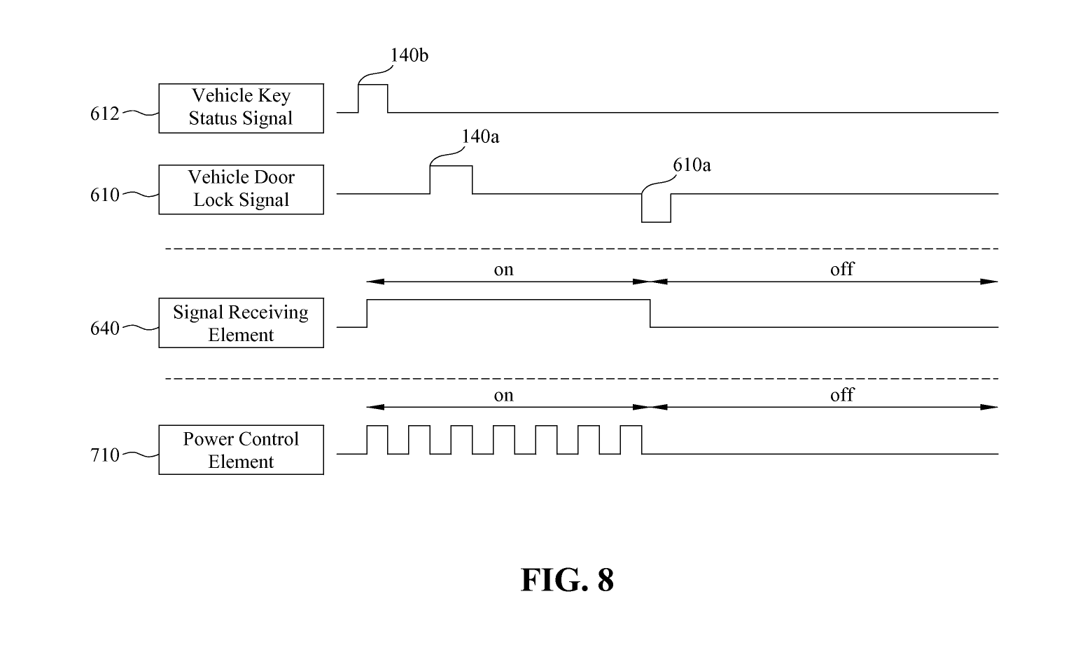

FIG. 8 shows a timing diagram of turning on or off the light source unit controlled by the control unit 110 controlled by the control unit 140 when the signal is a vehicle key status signal, according to an exemplary embodiment. Referring to FIG. 8, when the vehicle engine is stalled, it issues stall signal 140b. After the signal receiving element of the control unit 140 receives that the vehicle key status signal 612 is stall signal 140b, it notifies the power control element for supplying power to light source unit 110 to turn on the power. When the vehicle door is unlocked, unlock signal 140a is issued. The signal receiving element of the control unit 140 receives that the vehicle door lock signal 610 is unlock signal 140a. During the period of the signal receiving element staying at on, the power control element for supplying power to light source unit 110 continues turning on power. When the vehicle door is locked, the signal receiving element 640 of the control unit 140 receives that the vehicle door lock signal 610 is vehicle door locking signal 610a, the control unit 140 issues lock status turn off light source signal 620, and notifies the power control element for supplying power to light source unit 110 to turn off power.

Accordingly, the disclosed embodiments of hazard warning device and method for vehicles utilize a light source unit of small size, high brightness and easy to change color or light frequency (flicker), such as LED, and a light guiding unit such as vehicle window or rear windshield as guiding light material. The light source element may be combined in the light guiding unit or connected to an external light guiding unit. The side area or other available spaces of the vehicle doors are used to enter the light. With the guiding light materials of the light guiding unit or the external light guiding unit, the hazard warning device may output the light source to a large surface area on the vehicle window or appears warning pattern, word patterns, or images via the guiding light material. When the vehicle engine is stalled and before in the vehicle with door unlocked, or the handler sensor is going to be turned on, the control unit automatically controls light source unit and activates the light source unit, and displays timely and eye-catching warning to improve warning effect, prevents the rear coming vehicle especially motorcyclist from colliding accidents caused by opening door or moving of vehicle stops at road side. In the exemplary embodiments, the disclosed vehicle warning device also provides temporary lighting inside the vehicle.

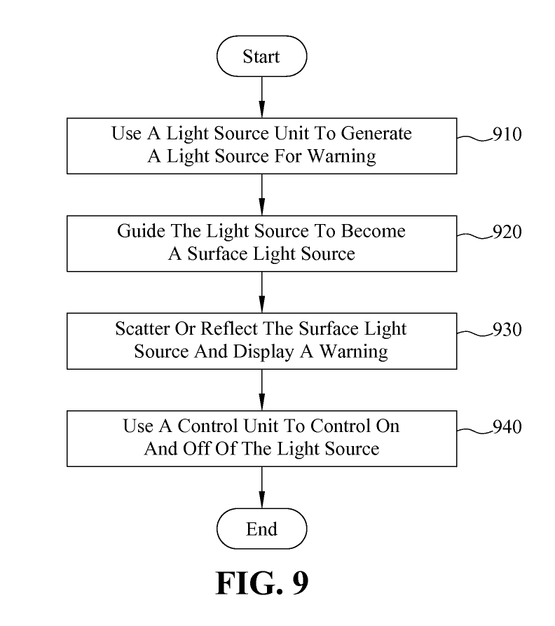

FIG. 9 shows a hazard warning method for vehicles, according to an exemplary embodiment. Referring to FIG. 9, this method first uses a light source unit to generate a light source for warning (step 910). Then, it guides the light source to become a surface light source having an area (step 920), and scatters or reflects the surface light source and displays a warning (step 930). It also uses a control unit to control the on and off of the light source (step 940). When the control unit receives an unlock signal or a stall signal from a vehicle, the control unit activates the light source unit and displays a warning on a surface area of the vehicle.

How to operate on and off of the light source by the control unit may be seen from the flow chart of FIG. 6, therefore, it is not repeated here. And from the flow chart of FIG. 6, it may be seen that the control unit further includes a signal receiving element to receive a signal. The signal may be a vehicle door lock signal or a vehicle key status signal. When the signal is a vehicle door lock signal, the control unit controls the timing of turning on or turning off the light source unit, as the timing diagram described in FIG. 7, and it is not repeated here. When the signal is a vehicle key status signal, the control unit controls the timing of turning on or turning off the light source unit, as the timing diagram described in FIG. 8, and it is omitted here.

In summary, the disclosed exemplary embodiments provide a vehicle warning technology. This technology utilizes a light source element with characteristics of small size, high brightness, such as LED, and either uses a guiding light element such as vehicle windows or rear windshield to combine with the light source element in a light guiding unit, or connects the light source element to an external light guiding unit. And, by using the guiding light element as guiding light material, this technology emits the light source from a large surface area. The light color or light frequency (flicker) for the light source may be chosen or changed. The technology only requires a guiding light element, and its warning effectiveness may be reached by installing a light source element and attaching a layer of a warning structural element.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A hazard warning device for vehicles, comprising:
a light source unit that generates a light source for warning;
a light guiding unit that guides said light source to become a surface light source;
a warning structure unit that scatters or reflects said surface light source and displays a warning; and
a control unit that is an element for controlling on and off of said light source unit;
wherein when the control unit receives an activation signal from a vehicle, the control unit activates the light source unit and displays a warning on a surface area of the vehicle via the light guiding unit and the warning structure unit.

2. The device as claimed in claim 1, wherein said light source generated by said light source unit enters into said light guiding unit via a light tube guiding element, and is switched to flashing or constant light by said control unit.

3. The device as claimed in claim 1, wherein said light tube guiding element takes said light source unit via one of an optical fiber, an optical fiber bundle, and a guiding light element to lead said light source to said light guiding unit.

4. The device as claimed in claim 1, wherein said light source unit takes one or more windows of said vehicle as guiding light material.

5. The device as claimed in claim 1, wherein said light guiding unit is a guiding light film, a guiding light plate, one or more windows of said vehicle, or a rear windshield of said vehicle, or any combination of the aforementioned.

6. The device as claimed in claim 1, wherein said warning is displayed as words, graphic patterns, or images, or one of combinations of the aforementioned according to application requirements.

7. The device as claimed in claim 1, wherein said light guiding unit takes a rear windshield of said vehicle as light guiding material.

8. The device as claimed in claim 1, wherein said light source generated by said light source unit enters directly into said light guiding unit, and one end of said light source unit connects to the control unit, the other end of said light source unit connects directly to the light guiding unit.

9. The device as claimed in claim 1, wherein said control unit further includes a signal receiving device, and when said signal receiving device receives an unlock signal of said vehicle, said control unit turns off said light source unit and terminates said warning displayed by said warning structure unit.

10. The device as claimed in claim 1, wherein said light source unit is at least one of a light-emitting diode and a cold cathode fluorescent lamp.

11. The device as claimed in claim 1, wherein said control unit further includes a signal receiving device to receive a signal, and said signal is one of a vehicle door lock signal and a vehicle key status signal.

12. The device as claimed in claim 1, wherein said control unit further includes a power control element to turn on or turn off a power for said light source unit.

13. A hazard warning method for vehicles, comprising:
generating a light source for warning by using a light source unit;
guiding said light source to become a surface light source;
scattering or reflecting said surface light source and displaying a warning; and
controlling the on and off of said light source unit by using a control unit;
wherein when the control unit receives an activation signal from a vehicle, the control unit activates the light source unit and displays a warning on a surface area of the vehicle via the light guiding unit and the warning structure unit.

14. The method as claimed in claim 13, wherein said control unit further includes a signal receiving device to receive a signal, and said signal is one of a vehicle door lock signal and a vehicle key status signal.

15. The method as claimed in claim 14, wherein said control unit further includes:
determining if said signal being said vehicle door lock signal or said vehicle key status signal;
when the signal being the vehicle door lock signal, determining if the vehicle lock signal being an unlock signal or a lock signal;
when the signal being the vehicle key status signal determining if said vehicle key status signal being a start signal or a stall signal;
when said vehicle door lock signal being the unlock signal or when said vehicle key status signal being the stall signal, the control unit turning on said light source unit; and
when the vehicle door lock signal being the lock signal or when said vehicle key status signal being the start signal, the control unit turning off the light source unit.

16. The method as claimed in claim 14, wherein when said signal is said vehicle door lock signal, said method further includes:
issuing said unlock signal when said vehicle door being unlocked;
after said signal receiving element of said control unit receiving said unlock signal, notifying a power control element for supplying a power to said light source unit to turn on said power; and
issuing a lock signal when said vehicle door being locked, and said signal receiving element of said control unit receiving the lock signal and notifying said power control element to turn off the power.

17. The method as claimed in claim 14, wherein when said signal is said vehicle key status signal, said method further includes:
issuing said stall signal when said vehicle being stalled;
after said signal receiving element of said control unit receiving said stall signal, notifying a power control element for supplying a power to said light source unit to turn on said power;
issuing said unlock signal, when said vehicle door being unlocked, and said signal receiving element of said control unit receiving the unlock signal;
during the period of said signal receiving element staying at on, the power control element continuing turning on the power; and
issuing a lock signal when the vehicle door being locked, and the signal receiving element of said control unit receiving the lock signal, notifying the power control element to turn off the power.
